(19) United States
(12) Patent Application Publication
(10) Pub. No.: US 2009/0051298 A1
(43) Pub. Date: Feb. 26, 2009

(54) Multiple discharge lamp lighting device

(76) Inventors: Hiroshi Shinmen, Kitasaku-gun (JP); Robert Weger, Wels (AT)

Correspondence Address: OLIFF & BERRIDGE, PLC, P.O. BOX 320850, ALEXANDRIA, VA, 22320-4850, US

(21) Appl. No.: 11/990,689

(22) PCT Filed: Jan. 15, 2007
(86) PCT No.: PCT/JP2007/050430

§ 371 Date: Feb. 20, 2008

(30) Foreign Application Priority Data
Feb. 9, 2006 (JP) 2006-032421

(51) Int. Cl. H05B 41/24

(52) U.S. Cl. 315/276

(57) ABSTRACT

A multiple discharge lamp lighting device in which lamp current of discharge lamps is equalized by using a circuit structure having transformers on both sides of the discharge lamps and in which the number of parts can be reduced. A multiple discharge lamp lighting device 10 according to the present invention includes the same number of first transformers TA1 to TAn as the number of discharge lamps La1 to Lan and one second transformer TB. One end of a secondary winding (e.g., Ns1) on the non-grounded side of the first transformer (e.g., TA1) is connected to one end of one corresponding discharge lamp (e.g., La1). One end of a secondary winding Ws on the non-grounded side of the second transformer TB is connected to a second end of each of the discharge lamps La1 to Lan. The potentials of the secondary windings Ns1 to Nsn on the non-grounded side of the first transformer TA1 to TAn and the potential of the secondary winding Ws on the non-grounded side of the second transformer TB are mutually changed with inverse phases.

### TECHNICAL FIELD

The present invention relates to a multiple discharge lamp lighting device that lights a plurality of discharge lamps. More particularly, the present invention relates to a multiple discharge lamp lighting device that lights a cold cathode lamp used as a light source for multiple-light backlight of a liquid crystal display device.

### BACKGROUND ART

In general, as a light source for a backlight of a liquid crystal display device, e.g., a discharge lamp such as a cold cathode lamp is widely used. In recent years, corresponding to high luminance and large scale of liquid crystal display devices, typically, e.g., display devices used for liquid crystal TVs, as an illumination light source of such a liquid crystal display device, a multiple-light backlight using a plurality of discharge lamps has been frequently used. Further, the large size of the cold cathode lamp used for a multiple-light backlight has increased.

Since the lighting operation of the cold cathode lamp generally requires a high voltage with a high frequency, the discharge lamp lighting device normally comprises inverter means that converts a DC voltage into an AC voltage with a high frequency and a transformer for increasing a voltage, and a high voltage with a high frequency generated on the secondary side of the transformer is applied by driving the primary side of the transformer with the inverter means, thereby lighting the cold cathode lamp.

The above-mentioned discharge-lamp lighting device has the following problem in view of the large size of the cold cathode lamp. That is, the large size of the cold cathode lamp increases a voltage necessary for the lighting operation. Therefore, a withstand voltage is sufficiently ensured for the transformer and the size of the cold cathode lamp is not thus able to be reduced. Further, in the discharge-lamp lighting device, one end of the cold cathode lamp is generally connected to the ground together with one end of a secondary winding of the transformer. Therefore, upon lighting the cold cathode lamp, only the potential of an electrode on the non-grounded side is greatly changed as compared with the ground potential. As a consequence, particularly in the case of the cold cathode lamp with the large size, a high luminance-gradient is caused in the longitudinal direction thereof and there is thus a problem that the quality of illumination deteriorates.

Conventionally, in order to solve the above problems, a discharge-lamp lighting device having the circuit structure shown in FIG. 15 has been proposed (refer to, e.g., Patent Document 1). A discharge-lamp lighting device 100 in FIG. 15 comprises: a first oscillation-transformer 121; a second oscillation-transformer 125; and oscillation circuits 122 and 126 that drive the oscillation transformers 121 and 125, first ends of secondary windings 121s and 125s in the oscillation transformers 121 and 125 being connected to the ground, and second ends thereof being connected to both ends of a cold cathode lamp 127 via ballast capacitors 128. Further, the discharge-lamp lighting device 100 generates voltages with inverse phases to ends of the secondary windings 121s and 125s, on the side thereof connected to the cold cathode lamp 127.

As compared with the case of lighting the cold cathode lamp 127 by using one transformer, in the discharge-lamp lighting device 100, voltages generated at the secondary windings 121s and 125s of the oscillation transformers 121 and 125 are reduced to half. The electrode potentials on both sides of the cold cathode lamp 127 are equally changed, with respect to the ground potentials. Consequently, the size of the transformer is easily reduced and the luminance gradient in the longitudinal direction is decreased.

Furthermore, as a cold cathode lamp having multiple lamps with the circuit structure for lighting the lamp by using a pair of transformers arranged at both ends thereof, a discharge-lamp lighting device has been proposed in which a plurality of the cold cathode lamps are connected in parallel therewith to the secondary sides of the pair of transformers (refer to, e.g., Patent Document 2). FIG. 16 is a diagram showing the circuit structure of a discharge-lamp lighting device 200. The discharge-lamp lighting device 200 comprises: a phase correcting circuit 206; a pair of high-frequency oscillation circuits 204A and 204B; and a pair of voltage increasing transformers 205A and 205B, one end of each of cold cathode lamps 220 being connected to one end of a secondary winding 252A of the voltage increasing transformer 205A via a ballast 202, and the other end of each of the cold cathode lamps 220 being connected to one end of the secondary winding 252B of the voltage increasing transformer 205B. In the discharge-lamp lighting device 200, voltages with inverse phases are generated at first ends of the primary winding 252A and the secondary winding 252B, on the connection sides of the cold cathode lamps 220.
Patent Document 1: Japanese Unexamined Utility Model Registration Application Publication No. 5-90897
Patent Document 2: Japanese Unexamined Patent Application Publication No. 2005-322504

### DISCLOSURE OF INVENTION

### Problems to be Solved by the Invention

Herein, if the multiple discharge lamp lighting device is structured by arranging a number of the circuit structures shown in FIG. 15 corresponding to a necessary number of lamps, a number of transformers corresponding to two times of the number of the cold cathode lamps used is required, and this causes an increase in costs. In view of this point, the discharge-lamp lighting device 200 shown in FIG. 16 lights a plurality of the cold cathode lamps 220 only by using the pair of transformers 205A and 205B, thereby reducing the number of transformers required. However, the discharge-lamp lighting device 200 has a problem that lamp current flowing in the cold cathode lamps 220 cannot be equalized. In order to equalize the lamp current, referring to FIG. 16, the ballast 202 including an inductor LB with high impedance is required for every cold cathode lamp 220, and costs cannot be sufficiently reduced.

In consideration of the above problems, it is an object of the present invention to provide a multiple discharge lamp lighting device in which lamp current of discharge lamps can be equalized and the number of parts required can be reduced by using a circuit structure having transformers on both sides of the discharge lamps.

### Means for Solving the Problems

In order to accomplish the object, according to the present invention, a multiple discharge lamp lighting device comprises a voltage increasing transformer and inverter means that converts a DC voltage into an AC voltage with a high frequency. The multiple discharge lamp lighting device lights a plurality of discharge lamps connected to a secondary winding of the transformer by driving a primary winding of the transformer with the inverter means. In the multiple discharge lamp lighting device, the transformer comprises a first transformer having the same number of outputs as the number of the discharge lamps and a second transformer having not less than one and less-than the number of the discharge lamps, and first ends of the secondary windings of the first transformer and the second transformer are connected to the ground, one end of the secondary winding on the non-grounded side of the first transformer is connected to one end of one corresponding discharge lamp, and one end of the secondary winding on the non-grounded side of at least one of the second transformers is connected to second ends of a plurality of the discharge lamps, and the potential on the non-grounded side of the secondary winding of the first transformer and the potential on the non-grounded side of the secondary winding of the second transformer are mutually changed with inverse phases.

In the multiple discharge lamp lighting device according to the present invention, first ends on the non-grounded sides of the secondary windings of the first transformer having the same outputs as the number of discharge lamps are connected to one end of one discharge lamp. One end of the secondary winding of the second transformer that is one or more and is less-than the number of the discharge lamps on the non-grounded side is connected to the other end of each of a plurality of discharge lamps, and the potential of the secondary winding of the first transformer on the non-grounded side and the potential of the secondary winding of at least one second transformer on the non-grounded side are mutually changed with inverse phases. Hence, in the multiple discharge lamp lighting device using the circuit structure having the transformers on both ends of the discharge lamps, the number of transformers necessary for the circuit structure is suppressed at the minimum level. Accordingly, this contributes to the reduction in size and costs of the discharge-lamp lighting device, in which the secondary voltage of the transformer is reduced and a plurality of discharge lamps are lit while reducing the luminance gradient in the longitudinal direction.

In the multiple discharge lamp lighting device according to the present invention, the primary windings of a plurality of the first transformers are preferably serially connected. As a consequence, the discharge lamps are equivalently serially connected, thereby easily equalizing the lamp current of the discharge lamps.

According to one aspect of the present invention, one end of the primary winding of the first transformer is connected to the inverter means via the ballast impedance element serially-connected to the primary winding.

The ballast impedance element is serially connected between the inverter means and the primary winding of the first transformer, thereby stabilizing the lamp current of the discharge lamps without arranging the ballast on the secondary side of the transformer. Further, the ballast impedance element is connected, not to the secondary side of the transformer to which a high voltage is applied, but to the primary side of the transformer, thereby reducing costs of parts without using the element with a high withstand-voltage. Further, a trouble due to the breakdown of element and a danger of ignition are prevented, thereby improving the safety of the device. In particular, in the case of using an inductor as the ballast impedance element, an inductance of the inductor is lower than that in the case of connecting the inductor to the secondary side and the size of the ballast impedance element therefore can be reduced.

According to another aspect of the present invention, in the multiple discharge lamp lighting device according to the present invention, a phase adjusting capacitor is connected to the primary winding of the first transformer in parallel therewith. As a consequence, since the deviation between a voltage phase and a current phase flowing to the transformer is small, the power factor and efficiency are improved. Further, a harmonic component of an output waveform of the inverter means is cut off and the current waveform of lamp current flowing to the discharge lamps is thus near being sinusoidal and the luminance efficiency of the discharge lamps can be improved.

According to another aspect of the present invention, in the multiple discharge lamp lighting device according to the present invention, a resonant circuit comprising a parasitic capacitance and a self-inductance of the transformer or exciting inductance is formed at a wiring on the secondary side of the transformer, and the inverter means drives a primary winding of the transformer at a frequency near a parallel oscillation frequency of the resonant circuit. As a consequence, the current flowing to the parasitic capacitance is supplied from the inductance of the transformer, and almost the current flowing to the transformer thus flows to the discharge lamps. The influence from the parasitic capacitance is thus reduced and the variation in lamp current flowing to the discharge lamps is suppressed.

According to another aspect of the present invention, in the multiple discharge lamp lighting device according to the present invention, a leakage inductance of the secondary winding of the transformer is used as a ballast impedance and a resonant circuit comprising the leakage inductance of the secondary winding of the transformer and a parasitic capacitance is formed at a wiring on the secondary side of the transformer. The inverter means is less than a serial oscillation frequency of the resonant circuit and is near a frequency having the minimum phase difference between the voltage and the current on the primary side of the transformer, and drives the primary winding of the transformer. As a consequence, the multiple discharge lamp lighting device can be operated at a frequency range within which the power efficiency of the transformer is maximum.

According to another aspect of the present invention, one discharge lamp may comprise two straight tubes formed by connecting electrodes on one-end side thereof and may alternatively comprise a bending tube. Further, in this case, the primary windings of the first transformer and the second transformer are driven by at least one of the inverter means, preferably, one inverter means. This structure is advantageous to arrange the discharge-lamp lighting device according to the present invention on one substrate.

According to another aspect of the present invention, the first transformer may include a transformer having one output and may alternatively include a transformer having two or more outputs.

According to another aspect of the present invention, the multiple discharge lamp lighting device according to the present invention is used for a backlight for a liquid crystal display device.

### Advantages

With the above-mentioned structure according to the present invention, it is possible to realize a multiple discharge lamp lighting device in which lamp current of discharge lamps can be equally kept and the number of parts can be reduced by using the circuit structure having transformers on both sides of the discharge lamps. In particular, it is possible to provide a multiple discharge lamp lighting device that is preferable to light a cold cathode lamp with large size used as a light source of a backlight for a liquid crystal display device.

### BRIEF DESCRIPTION OF THE DRAWINGS

FIG. 1 is a diagram showing the circuit structure of a multiple discharge lamp lighting device according to the first embodiment of the present invention;

FIG. 2 is a diagram schematically showing the circuit structure of a multiple discharge lamp lighting device according to the second embodiment of the present invention;

FIG. 3 is a diagram schematically showing the circuit structure of a multiple discharge lamp lighting device according to the third embodiment of the present invention;

FIG. 4 is a diagram schematically showing one example of the circuit structure of a multiple discharge lamp lighting device according to the fourth embodiment of the present invention;

FIG. 5 is a diagram schematically showing another example of the circuit structure of the multiple discharge lamp lighting device according to the fourth embodiment of the present invention;

FIG. 6 is a diagram showing one example of a first transformer in the multiple discharge lamp lighting device according to the present invention;

FIG. 7 is a diagram showing another example of the first transformer in the multiple discharge lamp lighting device according to the present invention;

FIG. 8 is a diagram schematically showing the circuit structure of a multiple discharge lamp lighting device according to the fifth embodiment of the present invention;

FIG. 9 is a diagram schematically showing the circuit structure of a multiple discharge lamp lighting device according to the sixth embodiment of the present invention;

FIG. 10 is a diagram schematically showing the circuit structure of a multiple discharge lamp lighting device according to the seventh embodiment of the present invention;

FIG. 11 is a diagram schematically showing the circuit structure of a multiple discharge lamp lighting device according to the eighth embodiment of the present invention;

FIG. 12 is a diagram schematically showing the circuit structure of a multiple discharge lamp lighting device according to the ninth embodiment of the present invention;

FIG. 13 is a diagram schematically showing the circuit structure of a multiple discharge lamp lighting device according to the tenth embodiment of the present invention;

FIG. 14 is a diagram showing an example of a transformer in the multiple discharge lamp lighting device according to the tenth embodiment of the present invention;

FIG. 15 is a diagram showing the circuit structure of one example of a conventional discharge-lamp lighting device; and

FIG. 16 is a diagram showing the circuit structure of another example of the conventional discharge-lamp lighting device.

### REFERENCE NUMERALS

10, 20, 30, 40, 50, 60, 70, 85, 90, 95: multiple discharge lamp lighting device
12A and 12B: inverter means
TA1 to TAn: first transformer
Np1 to Npn: primary winding of first transformer
Ns1 to Nsn: secondary winding of first transformer
Ls1 to Lsn: leakage inductance of secondary winding of first transformer
TB, TB1, TB2: second transformer
Wp, Wp1, Wp2: primary winding of second transformer
Ws, Ws1, Ws2: secondary winding of second transformer
Ltb: leakage inductance of secondary winding of second transformer
La1 to Lan: discharge lamp
Cs: parasitic capacitance

### BEST MODE FOR CARRYING OUT THE INVENTION

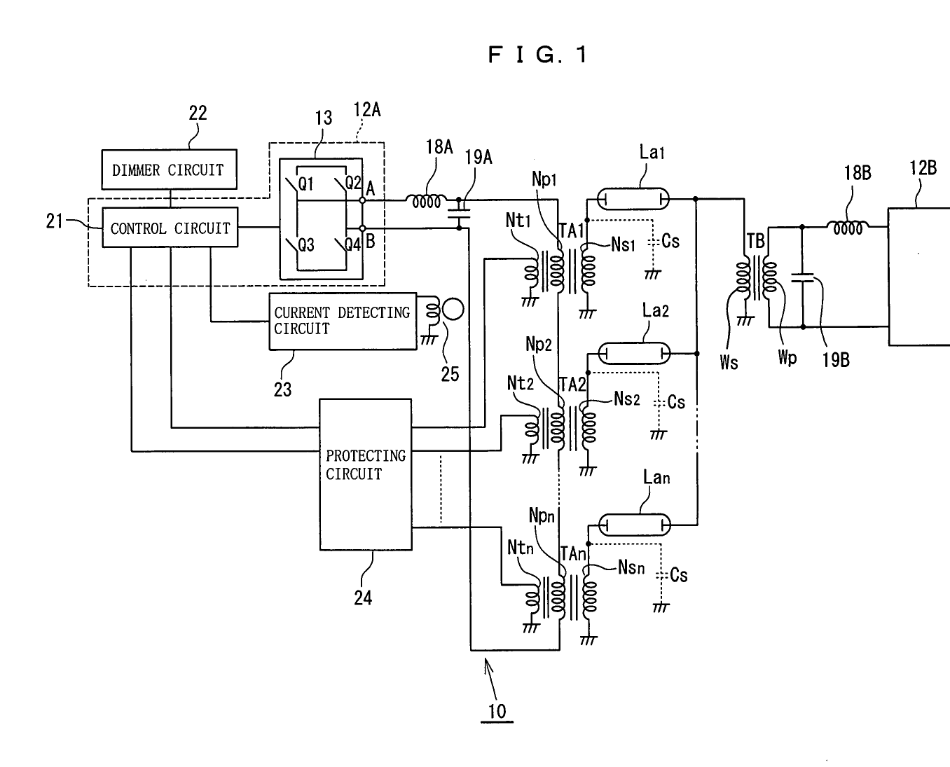

Hereinbelow, a specific description will be given of a multiple discharge lamp lighting device according to embodiments with reference to the drawings. FIG. 1 is a diagram showing the circuit structure of a multiple discharge lamp lighting device 10 that controls lighting operation of a plurality of (herein, n) discharge lamps La1 to Lan according to an embodiment of the present invention.

The multiple discharge lamp lighting device 10 comprises: inverter means 12A and 12B; n first-transformers TA1 to TAn; and one second-transformer TB. According to the embodiment, primary windings Np1 to Npn of the first transformers TA1 to TAn are serially connected (hereinafter, all the primary windings Np1 to Npn serially connected are referred to as a primary winding Np). One end of the primary winding Np is connected to an output terminal A of the inverter means 12A via an inductor 18A (ballast impedance element) serially connected to the primary winding Np, and the other end of the primary winding Np is connected to an output terminal B of the inverter means 12A. Further, a phase adjusting capacitor 19A is connected between a line on the side of the output terminal A and a line on the side of the output terminal B of the primary winding Np, in parallel with the primary winding Np. Furthermore, a primary winding Wp of the second transformer TB is connected to the inverter means 12B, an inductor 18B (ballast impedance element) is serially connected to the primary winding Wp, and a phase adjusting capacitor 19B is connected to the primary winding Wp in parallel therewith.

First ends of secondary windings Ns1 to Nsn of the first transformers TA1 to TAn and one end of a secondary winding Ws of the second transformer TB are connected to the ground. In each of the discharge lamps La1 to Lan, one end of a secondary winding Nsi (i=1, 2, . . . , n) on the non-grounded side of a first transformer TAi (i=1, 2, . . . n) is connected to one end of a corresponding discharge lamp Lai (i=1, 2, . . . , n) having one lamp, and one end of the secondary winding Ws on the non-grounded side of the second transformer TB is connected to a second end of each of all the discharge lamps La1 to Lan. Hence, the discharge lamps La1 to Lan are directly connected to circuits on the secondary sides of the first transformers TA1 to TAn and the second transformer TB without arranging a ballast element. Further, referring to FIG. 1, a capacitor Cs shown by a broken line represents the parasitic capacitance of the circuits on the secondary side of the first transformers TA1 to TAn and the second transformer TB.

Incidentally, the first transformers TA1 to TAn are structured by using the n transformers having one output of the secondary winding according to the embodiment. However, the multiple discharge lamp lighting device according to the present invention may include a first transformer having the same number of outputs as the number of discharge lamps, and alternatively may include a transformer having two (or more) outputs of the secondary winding. In this case, the number of transformers required as the first transformers is reduced, corresponding to the number of outputs of the transformers. With respect to the multiple discharge lamp lighting device according to the present invention, a description will be later given of the specific structure of the transformer preferable to be used as the first transformer.

Herein, the inverter means 12A comprises: a full-bridge circuit serving as switching means 13; and a control circuit 21 that drives the full-bridge circuit 13. The full-bridge circuit 13 is formed by connecting a pair of serially connected switching elements Q1 and Q3 to a pair of serially connected switching elements Q2 and Q4. For example, the switching elements Q1 and Q2 comprise PMOSFETs, and the switching elements Q3 and Q4 comprise NMOSFETs. The inverter means 12 alternately repeats, at a predetermined frequency, on/off-operation of the pairs of the switching elements (Q1, Q4) and (Q2, Q3) in accordance with a gate voltage output from the control circuit 21, converts a DC voltage Vin (not shown) into an AC voltage with a high frequency, and outputs the converted voltage to the output terminals A and B.

Although not shown, the inverter means 12B according to the embodiment comprises the switching means 13 and the control circuit 21. Further, although the inverter means 12B is a block independent of the inverter means 12A as shown in FIG. 1, the switching means 13 or the control circuit 21, or both of the switching means 13 and the control circuit 21 in the inverter means 12B according to the embodiment may be shared by the corresponding components in the inverter means 12A.

Moreover, the multiple discharge lamp lighting device 10 comprises: a dimmer circuit 22; a current detecting circuit 23; and a protecting circuit 24, in addition to the above-mentioned components. The multiple discharge lamp lighting device according to the present invention is not limited to the presence or absence of the circuits 22 to 24. However, a brief description will be given of functions of the circuits 22 to 24 as follows. First of all, the current detecting circuit 23 generates a proper signal corresponding to a current value detected by a current transformer 25, and outputs the generated signal to the control circuit 21. Thus, the control circuit 21 changes the on-duty of the switching elements Q1 to Q4 included in the inverter means 12, and adjusts power supplied to the first transformers TA1 to TAn. The protecting circuit 24 generates proper signals corresponding to voltages detected by tertiary windings Nt1 to Ntn of the first transformers TA1 to TAn, and outputs the generated signals to the control circuit 21. Thus, if detecting an abnormal state such as open-circuit or short-circuit of the discharges lamp La1 to Lan, the control circuit 21 stops the operation of the inverter means 12 and protects the device. Further, the dimmer circuit 22 outputs, to the control circuit 21, a signal for adjusting the luminance of the discharge lamps La1 to Lan by, e.g., burst dimming. As a consequence, the control circuit 21 intermittently operates the inverter means 12 at a frequency of 150 to 300 Hz, thereby adjusting the average luminance of the discharge lamps La1 to Lan. In the example shown in the drawing, the current detecting circuit 23 detects the current on the primary side by using the current transformer 25. Alternatively, a current detecting circuit including a current detecting resistor may be arranged on the ground side of the secondary windings Ns1 to Nsn of the first transformers TA1 to TAn, thereby detecting lamp current of the discharge lamps La1 to Lan.

In the multiple discharge lamp lighting device 10 with the above-mentioned structure, the potentials on the non-grounded side of the secondary windings Ns1 to Nsn of the first transformers TA1 to TAn and the potential on the non-grounded side of the secondary winding Ws of the second transformer TB are mutually changed with inverse phases and a predetermined voltage is thus applied to both ends of each of the discharge lamps La1 to Lan, thereby lighting the discharge lamps La1 to Lan. In this case, the transformers TA1 to TAn and TB are arranged at both ends of each of the discharge lamps La1 to Lan in the multiple discharge lamp lighting device 10. Accordingly, it is advantageous to decrease, to half, the voltages generated at the secondary windings Ns1 to Nsn and Ws, serving and further reduce the size of the transformers TA1 to TAn and TB, as the feature of the circuit structure. Moreover, it is advantageous to equally change the electrode potentials on both ends of each of the discharge lamps La1 to Lan for the ground potential so as to reduce the luminance gradient of the discharge lamps La1 to Lan in the longitudinal direction thereof. In addition, the number of necessary transformers is suppressed to the minimum level (that is, “the number (n) of the discharge lamps+1” according to the embodiment), and the multiple light is realized with the above-mentioned circuit structure.

In the multiple discharge lamp lighting device 10 according to the embodiment, the primary windings Np1 to Npn of the first transformers TA1 to TAn are serially connected, thereby allowing common current to flow on the primary side to the primary windings Np1 to Npn of the first transformers TA1 to TAn. Equivalently, the discharge lamps La1 to Lan are serially connected, thereby equalizing the lamp current of the discharge lamps La1 to Lan.

Since the ballast impedance element (the inductor 18A) is serially connected to the primary winding Np, a high withstand-voltage is not required. Further, a single ballast impedance element with relatively low impedance stabilizes the lamp current of the discharge lamps La1 to Lan. In the multiple discharge lamp lighting device 10 according to the embodiment, upon using the inductor 18A as the ballast impedance element, the size of the inductor 18A is reduced. Incidentally, the phase adjusting capacitor 19A has a function for reducing the phase difference between the voltage and current, thereby improving the power factor and the efficiency. Further, a harmonic component of an output voltage from the inverter means 12A is effectively cut-off, thereby setting, to be approximately sinusoidal, voltage waveforms applied to the primary windings Np of the first transformers TA1 to TAn. Since the lamp current flowing to the discharge lamps La1 to Lan is approximately sinusoidal, the luminance efficiency is improved.

In the multiple discharge lamp lighting device 10 according to the first embodiment, a resonant circuit comprising self-inductances of the transformers TA1 to TAn and TB or exciting inductance and parasitic capacitance Cs is formed at the wiring on the secondary side of the first transformers TA1 to TAn and the second transformer TB. Preferably, the inverter means 12A and 12B drives the primary windings Np1 to Npn and Wp of the transformers TA1 to TAn and TB at a frequency near a parallel resonant frequency of the resonant circuit. Thus, the current flowing to the parasitic capacitance Cs is supplied from the inductances of the transformers TA1 to TAn and TB, and almost all of the current flowing to the transformers TA1 to TAn and TB thus flows to the discharge lamps La1 to Lan. As a consequence, the influence from the parasitic capacitance Cs is reduced and the variation in lamp current flowing to the discharge lamps La1 to Lan is suppressed.

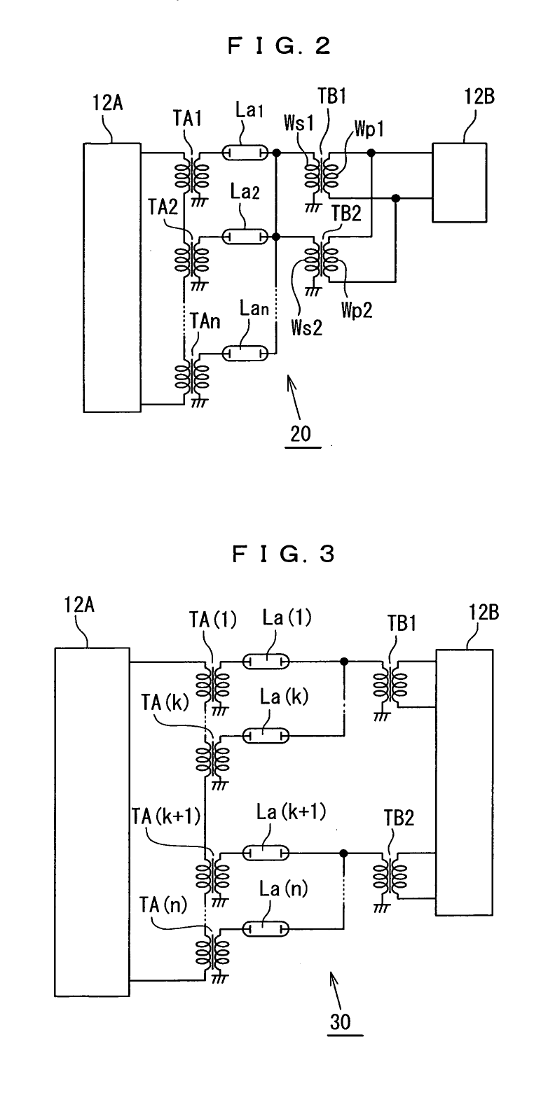

Hereinbelow, a description will be given of a multiple discharge lamp lighting device according to another embodiment of the present invention with reference to FIGS. 2 to 5. In the following description, the drawing and description are omitted according to the necessity with respect to the same portions in the multiple discharge lamp lighting device 10 described with reference to FIG. 1, and different points will be specifically described.

FIG. 2 is a diagram schematically showing a multiple discharge lamp lighting device according to the second embodiment of the present invention. A multiple discharge lamp lighting device 20 shown in FIG. 2 comprises two second transformers TB1 and TB2, unlike the multiple discharge lamp lighting device 10 shown in FIG. 1 (in this case, the number n of the discharge lamps>2). Further, in the second transformers TB1 and the second transformer TB2 according to the second embodiment, first ends on the non-grounded side of secondary windings Ws1 and Ws2 are connected to first ends, opposite to the connection side to the first transformers TA1 to TAn, of all the discharge lamps La1 to Lan.

As compared with the multiple discharge lamp lighting device 10, the numbers of the second transformers TB1 and TB2 are increased in the multiple discharge lamp lighting device 20 according to the second embodiment and the current flowing to the secondary windings Ws1 and Ws2 however is reduced to the half. Therefore, it is characterized that the individual transformers TB1 and TB2 are reduced in size. In the multiple discharge lamp lighting device according to the second embodiment of the present invention, the number of the second transformers is properly determined in consideration of member costs and attachment conditions of the individual transformers and, as long as the number of the second transformers is less than the number of the discharge lamps, the above-mentioned operation and advantage are obtained unlike the conventional circuit structure.

Referring to FIG. 2, primary windings Wp1 and Wp2 of the second transformers TB1 and TB2 are connected to the inverter means 12B in parallel therewith. This connection enables the reduction in current flowing to the primary windings Wp1 and Wp2, as compared with the case of serially connecting the primary windings Wp 1 and Wp2, and is therefore advantageous for reduction in size of the transformer. However, the multiple discharge lamp lighting device according to the present invention is not limited to the connection of the primary windings Wp1 and Wp2.

FIG. 3 is a diagram schematically showing the circuit structure of a multiple discharge lamp lighting device according to the third embodiment of the present invention. Commonly to the multiple discharge lamp lighting device 20 shown in FIG. 2, a multiple discharge lamp lighting device 30 shown in FIG. 3 comprises the two second transformers TB1 and TB2. Unlike the multiple discharge lamp lighting device 20 shown in FIG. 2, a plurality of discharge lamps (the number n of the discharge lamps>2) comprise a first set of discharge lamps La(1) to La(k) and a second set of discharge lamps La(k+1) to La(n) (herein, 1≦k<n), one end of the non-grounded side of the secondary winding Ws1 of the second transformer TB1 is connected to first ends, on the opposite side of the first transformers TA(1) to TA(k), of the discharge lamps La(1) to La(k) forming the first set, and one end of the non-grounded side of the secondary winding Ws2 of the second transformer TB2 is connected to first ends, on the opposite side of the connection to the first transformers TA(k+1) to TA(n), of the discharge lamps La(k+1) to La(n) forming the second set.

As compared with the multiple discharge lamp lighting device 20, in the multiple discharge lamp lighting device 30 according to the second embodiment, upon mounting the second transformer TB1 and the second transformer TB2 on individual substrates, the substrates are advantageously structured without connection by a high-voltage wiring on the secondary side of the second transformers TB1 and TB2.

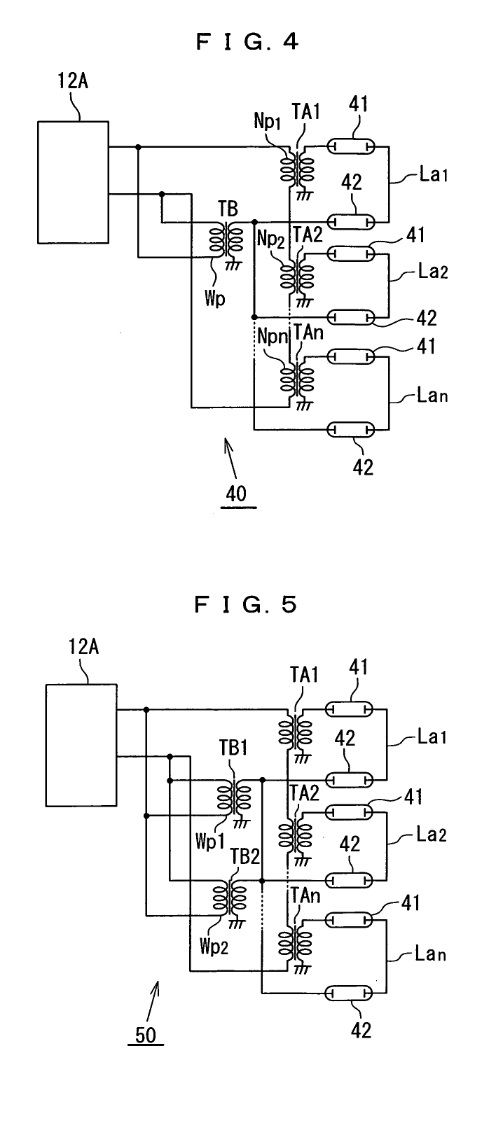

FIGS. 4 and 5 are diagrams schematically showing a multiple discharge lamp lighting device according to the fourth embodiment of the present invention. Unlike the multiple discharge lamp lighting device 10 shown in FIG. 1, in a multiple discharge lamp lighting device 40 shown in FIG. 4, the discharge lamps La1 to Lan individually comprise two straight tubes 41 and 42 obtained by connecting electrodes on the one-end side thereof, and the primary winding Np for serially connecting the primary windings Np1 to Npn of the first transformers TA1 to TAn is connected to the primary winding Wp of the second transformer TB with respect to one inverter means 12A in parallel therewith. Further, as compared with the discharge-lamp lighting device 40, a discharge-lamp lighting device 50 shown in FIG. 5 comprises the two second transformers TB1 and TB2 as an example.

Advantageously, in the multiple discharge lamp lighting devices 40 and 50 according to the second embodiment, at least the first transformers TA1 to TAn and the second transformer TB are mounted on one substrate. This contributes to the reduction in size of the multiple discharge lamp lighting device according to the present invention. In this case, in the multiple discharge lamp lighting device 40 (or 50) shown in FIGS. 4 and 5, preferably, one inverter means 12A drives the first transformers TA1 to TAn and the second transformer TB (or TB1 and TB2). However, the discharge-lamp lighting device according to the present invention is not limited to this structure. Incidentally, in the multiple discharge lamp lighting device 50, the primary windings Wp1 and Wp2 of the second transformers TB1 and TB2 are connected in parallel therewith because of the same reason of the multiple discharge lamp lighting device 20 shown in FIG. 2.

Although not shown, in the multiple discharge lamp lighting devices 40 and 50, the discharge lamps La1 to Lan can comprise one bending tube such as a U-shaped tube.

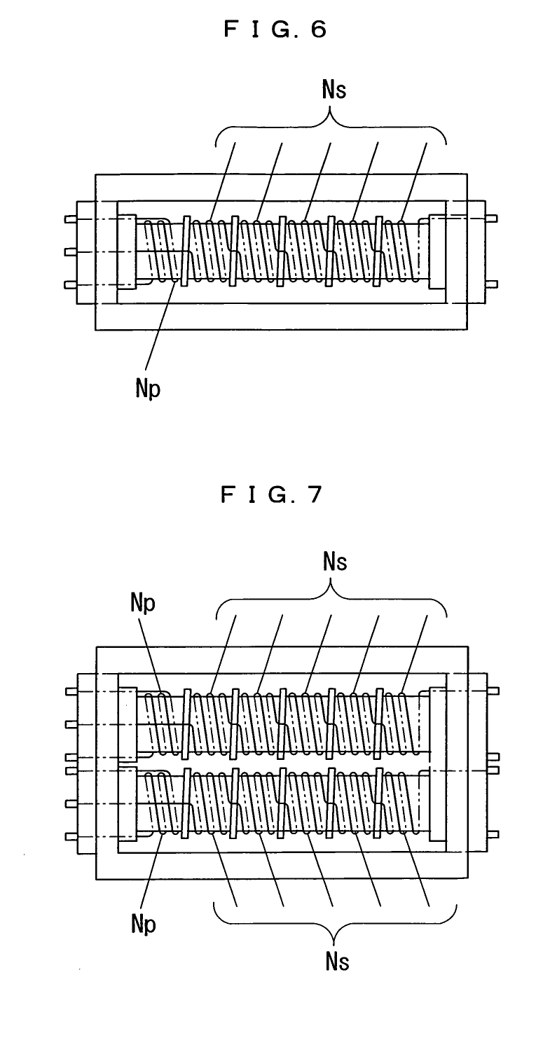

Herein, FIG. 6 shows first transformers TA1 to TAn in the multiple discharge lamp lighting devices 10 to 50 in one preferable example. The transformer shown in FIG. 6 is a transformer having one output of the secondary winding, includes a core obtained by combination of squared shape and I-shape, and is formed by attaching a bobbin formed by winding the primary winding Np and the secondary winding Ns to the I-core. As mentioned above, the first transformer in the multiple discharge lamp lighting device according to the present invention may include a transformer having two or more outputs of the secondary winding. For example, as the preferable structure of the transformer having two outputs of the secondary winding, the transformer as shown in FIG. 7 includes a core obtained by combination of squared shape and I-shape having two I-cores and is formed by attaching a bobbin obtained by winding the primary winding Np and the secondary winding Ns to the I-cores. Further, the transformer in the multiple discharge lamp lighting device according to the present invention is not limited to the above-mentioned core shapes, and can use, e.g., an EE-core, an EI-core, a UU-core, and a UI-core.

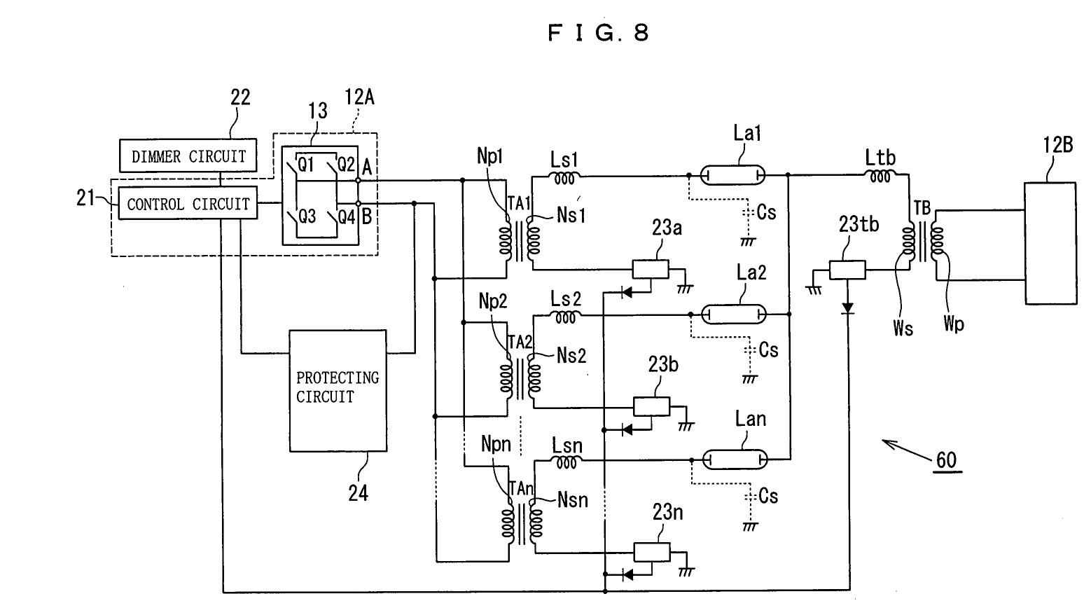

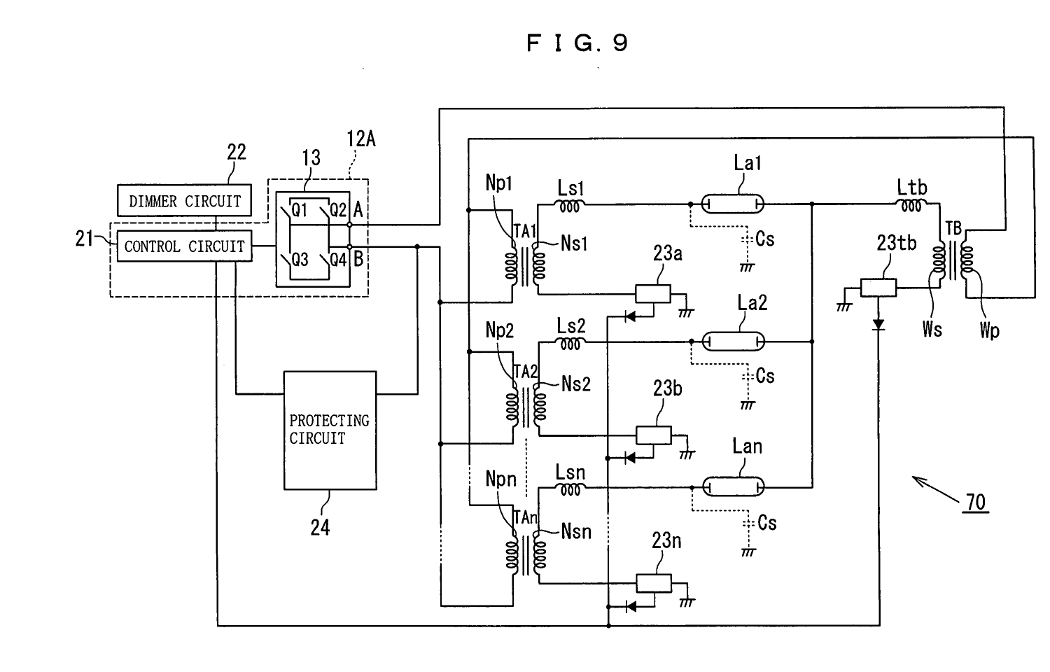

The multiple discharge lamp lighting device according to the embodiments of the present invention is described. However, the multiple discharge lamp lighting device is not limited to the discharge lamp lighting devices 10 to 50, and may be structured by connecting the primary windings Np1 to Npn of the first transformers TA1 to TAn shown in FIG. 1 to the inverter means 12A in parallel therewith. FIG. 8 is a diagram schematically showing the circuit structure of a multiple discharge lamp lighting device according to the fifth embodiment of the present invention. Referring to FIG. 8, the primary windings Np1 to Npn of the first transformers TA1 to TAn are connected to the inverter means 12A in parallel therewith and leakage inductances Ls1 to Lsn of the secondary windings Ns1 to Nsn in the first transformers TA1 to TAn function as the ballast impedance elements, thereby equalizing the lamp current of the discharge lamps La1 to Lan.

In this case, a resonant circuit comprising the leakage inductances Ls1 to Lsn and Ltb of the transformers TA1 to TAn and TB thereof and the parasitic capacitance Cs is formed to a circuit on the secondary side of the first transformers TA1 to TAn and the second transformer TB. In general, an inverter transformer is operated with preferable power efficiency at a frequency having a small range of the phase difference between the voltage and the current on the primary side, and the frequency of the inverter transformer is included within a frequency range lower than a serial resonant frequency of a resonant circuit on the secondary side. Preferably, the inverter means 12A and 12B therefore drives the primary windings Np1 to Npn and Wp of the first transformers TA1 to TAn and the second transformer TB at a frequency that is less than the serial resonant frequency of the resonant circuit on the secondary side and is near a frequency having the minimum phase difference between the voltage and the current on the primary side of the first transformers TA1 to TAn and the second transformer TB. The drive frequency can be a frequency having the phase difference between the voltage and the current on the primary side ranging from 0° to −30°.

In addition, upon using the leakage inductances of the first transformers TA1 to TAn and the second transformer TB as the ballast impedance elements, if the leakage inductances have a sufficiently value as the ballast impedance elements, referring to FIG. 8, the ballast impedance elements 18A and 18B shown in FIG. 1 can be removed by using the leakage inductances Ls1 to Lsn and Ltb of the secondary windings Ns1 to Nsn and Ws of the first transformers TA1 to TAn and the second transformer TB as the ballast impedance elements. Further, if designing the drive frequency of the inverter means 12A and 12B so that the phase difference between the voltage and the current on the primary side of the first transformers TA1 to TAn and the second transformer TB ranges from 0° to −30° as mentioned above, the phase adjusting capacitors 19A and 19B shown in FIG. 1 can also be removed. Further, referring to FIG. 8, current detecting circuits 23a to 23n and 23tb are arranged on the individual ground sides of the secondary windings Ns1 to Nsn and Ws of the first transformers TA1 to TAn and the second transformer TB, and signals therefrom are output to the control circuit 21.

FIG. 9 is a diagram schematically showing the circuit structure of a multiple discharge lamp lighting device according to the sixth embodiment of the present invention. Unlike the multiple discharge lamp lighting device 60 shown in FIG. 8, in a multiple discharge lamp lighting device 70 according to the sixth embodiment, the primary windings Np1 to Npn of the first transformers TA1 to TAn connected in parallel therewith on the primary side are serially connected to the primary winding Wp of the second transformer TB. This connection enables easy setting, to 180°, of the phase difference between current output from the secondary windings Ns1 to Nsn of the first transformers TA1 to TAn to the discharge lamps La1 to Lan and current output from the secondary winding Ws of the second transformer TB to the discharge lamps La1 to Lan, thereby improving the efficiency.

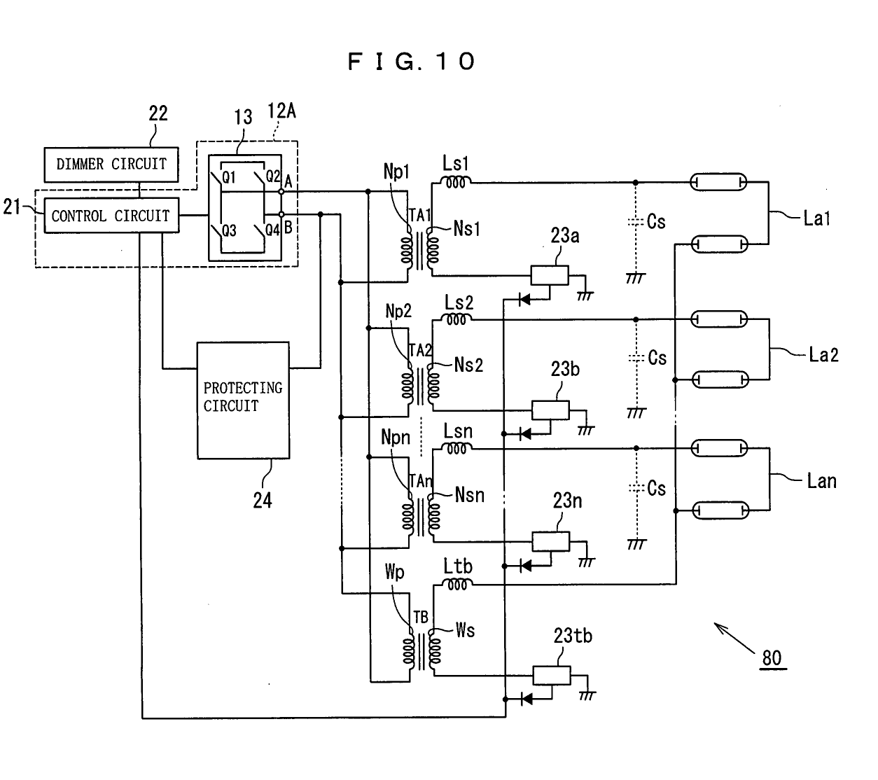

FIG. 10 is a diagram schematically showing the circuit structure of a multiple discharge lamp lighting device according to the seventh embodiment of the present invention. Unlike the multiple discharge lamp lighting device 60 shown in FIG. 8, in a multiple discharge lamp lighting device 80 according to the seventh embodiment, the discharge lamps La1 to Lan individually comprise two straight tubes obtained by connecting electrodes on one end thereof, and the primary winding Np having the primary windings Np1 to Npn of the first transformers TA1 to TAn connected in parallel therewith is connected to the primary winding Wp of the second transformer TB in parallel therewith in relation to one inverter means 12A.

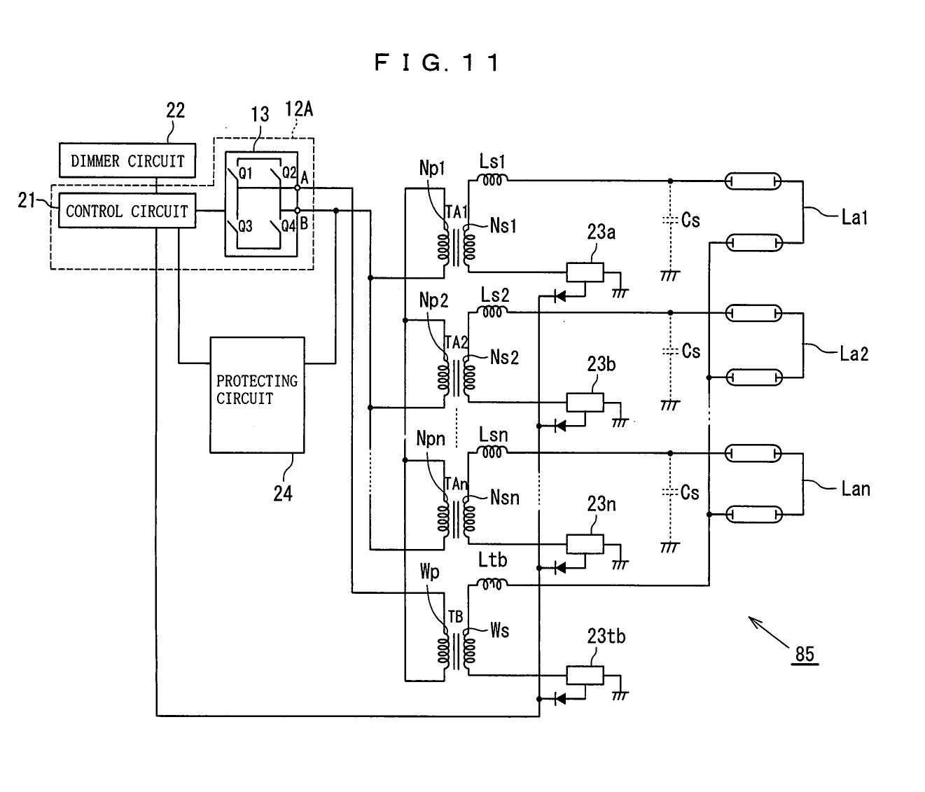

FIG. 11 is a diagram schematically showing the circuit structure of a multiple discharge lamp lighting device according to the eighth embodiment of the present invention. Unlike the multiple discharge lamp lighting device 70 shown in FIG. 9, in a multiple discharge lamp lighting device 85 according to the eighth embodiment, the discharge lamps La1 to Lan individually comprise two straight tubes obtained by connecting electrodes on one end thereof.

The discharge-lamp lighting devices 80 and 85 shown in FIGS. 10 and 11 have an advantageous structure to mount the first transformers TA1 to TAn and the second transformer TB on one substrate. Further, advantageously, the size thereof can be reduced.

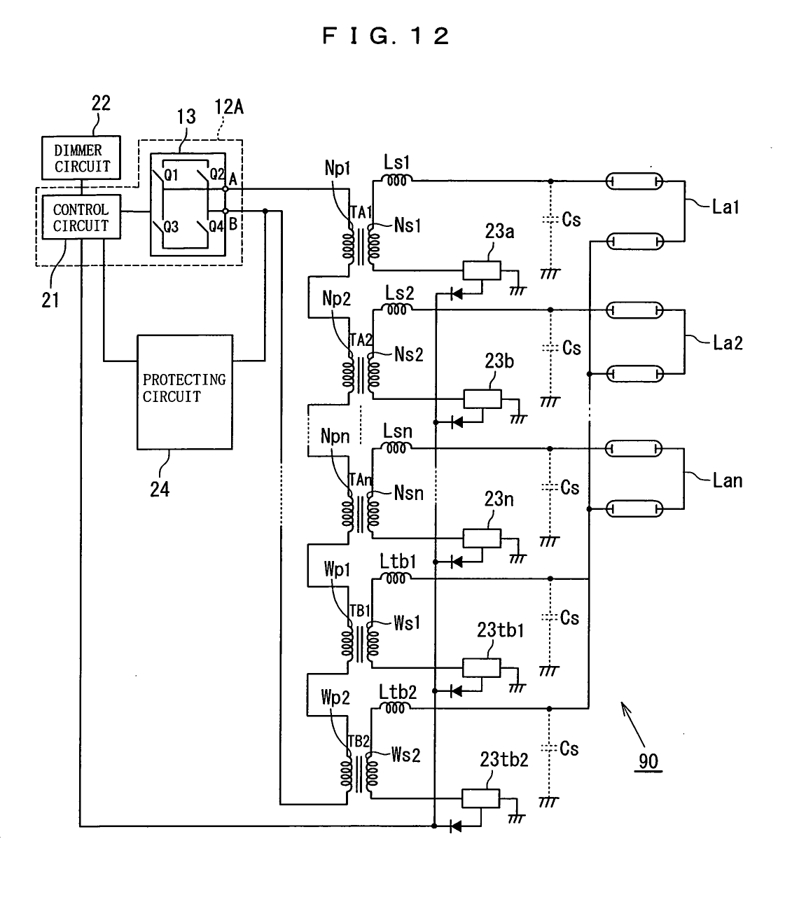

FIG. 12 is a diagram schematically showing the circuit structure of a multiple discharge lamp lighting device according to the ninth embodiment of the present invention. Unlike the multiple discharge lamp lighting device 50 shown in FIG. 5, in a multiple discharge lamp lighting device 90 according to the ninth embodiment, the primary windings Np1 to Npn of the first transformers TA1 to TAn are serially connected to the primary windings Wp 1 to Wp2 of the second transformers TB1 to TB2, and there is not the phase difference between current waveforms output from the first transformers TA1 to TAn and current waveforms output from the second transformers TB1 to TB2, thereby enabling efficient driving. Further, the second transformers TB1 to TB2 on the secondary side are connected in parallel therewith, thereby reducing the output impedance. This is advantageous to match the discharge lamps La1 to Lan connected to the second transformers TB1 to TB2 in parallel therewith. Incidentally, the second transformers TB1 to TB2 on the primary side may be serially connected and, alternatively, may be connected in parallel therewith.

Further, in the multiple discharge lamp lighting device 10 according to the first embodiment shown in FIG. 1, the primary windings Nt1 to Ntn of the first transformer are serially connected. In the multiple discharge lamp lighting device 60 according to the fifth embodiment shown in FIG. 8, the primary windings Nt1 to Ntn of the first transformer are connected in parallel therewith. However, the primary windings Nt1 to Ntn may be connected by combination of the serial connection and the parallel connection.

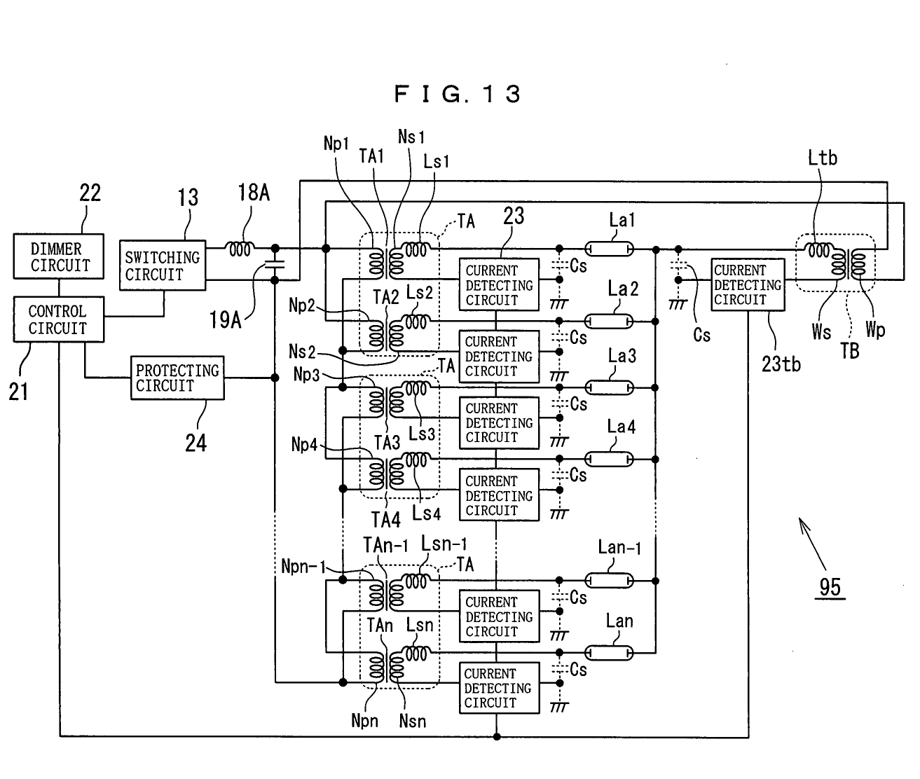

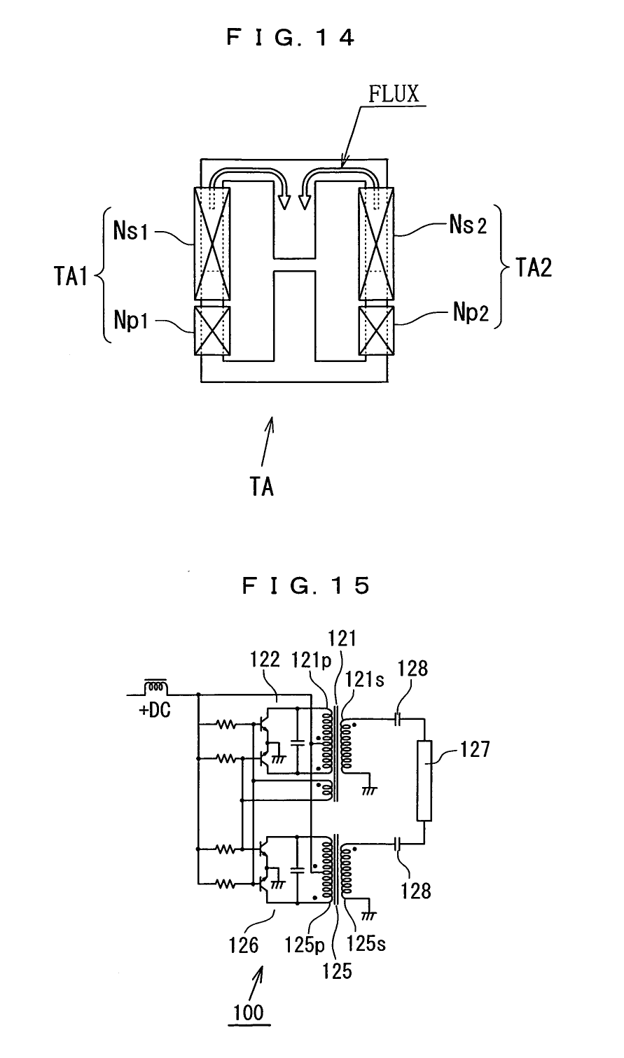

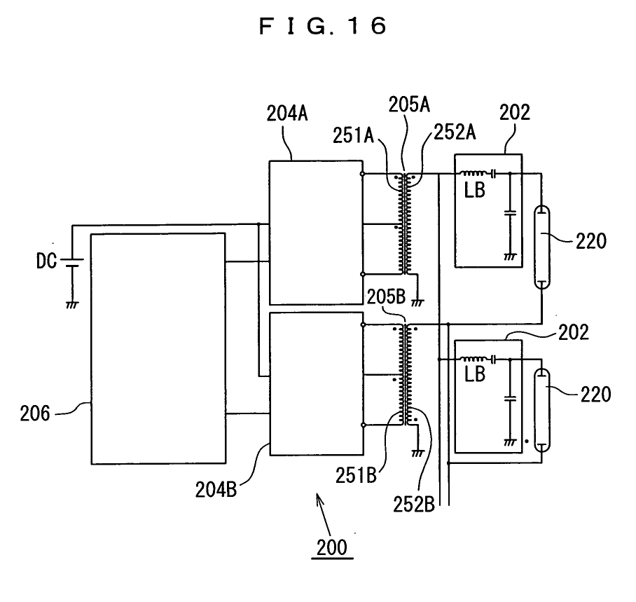

FIG. 13 is a diagram schematically showing the circuit structure of a multiple discharge lamp lighting device according to the tenth embodiment of the present invention. In a multiple discharge lamp lighting device 95 according to the tenth embodiment, the first transformers TA1 to TAn are structured by using a transformer TA (corresponding to a portion shown by a dotted line in FIG. 13) having two outputs of the secondary winding. FIG. 14 is a diagram showing the schematic structure of a transformer TA forming first transformers TA1 and TA2 as an example. Other first transformers TA3 and TA4, . . . , TAn−1 and TAn are similarly structured. Referring to FIG. 14, the transformer TA comprises an EE-core, the transformer TA1 is structured by winding the primary winding Np1 and the secondary winding Ns1 to one side of leg portions on both sides, and the transformer TA2 is structured by winding the primary winding Np2 and the secondary winding Ns2 to the other side of the leg portions on both the sides. The transformer TA comprising the EE-core shown in FIG. 14 does not have the gap between cores of the two primary windings Np1 and Np2 or the gap between cores of the two secondary windings Ns1 and Ns2, as compared with the transformer comprising the core obtained by combination of squared shape and I-shape shown in FIG. 7. Thus, fluxes generated from the windings via the cores easily interfere with each other (a flux flow is shown in FIG. 14). At the transformer TA, if serially connecting the two primary windings Np1 and Np2, voltages applied to the primary windings Np1 and Np2 cannot be identical, thereby easily non-uniformizing the lamp current. Therefore, in the multiple discharge lamp lighting device 95, the primary windings Np1 and Np2, Np3 and Np4, . . . , Npn−1 and Npn are connected in parallel therewith. Accordingly, the same voltage is applied to the two primary windings Np1 and Np2, Np3 and Np4, . . . , Npn−1 and Npn forming the pairs of windings. Further, by serially connecting the pairs of windings formed by connecting the two primary windings Np 1 and Np2, Np3 and Np4, . . . , Npn−1 and Npn in parallel therewith, the current flowing to the primary windings Np1 to NPn of the first transformers TA1 to TAn is equalized. Incidentally, the transformer TA shown in FIG. 14 has the gap at the leg portion in the center. However, the transformer TA according to the tenth embodiment may not have the gap at the leg portion in the center.

1. A multiple discharge lamp lighting device comprising a voltage increasing transformer and inverter means that converts a DC voltage into an AC voltage with a high frequency, the multiple discharge lamp lighting device lighting a plurality of discharge lamps connected to a secondary winding of the transformer by driving a primary winding of the transformer with the inverter means,
wherein the transformer comprises a first transformer having the same number of outputs as the number of the discharge lamps and a number of second transformers, not less than one and less than the number of the discharge lamps, and first ends of the secondary windings of the first transformer and the second transformer are connected to the ground,
one end of the secondary winding on the non-grounded side of the first transformer is connected to one end of each of the discharge lamps, and one end of the secondary winding on the non-grounded side of at least one of the second transformers is connected to second ends of a plurality of the discharge lamps, and
the potential on the non-grounded side of the secondary winding of the first transformer and the potential on the non-grounded side of the secondary winding of the second transformer are mutually changed with inverse phases.

2. The multiple discharge lamp lighting device according to claim 1, wherein the primary windings of a plurality of the first transformers are serially connected.

3. The multiple discharge lamp lighting device according to claim 1, wherein one end of the primary winding of the first transformer is connected to the inverter means via a ballast impedance element serially connected to the primary winding.

4. The multiple discharge lamp lighting device according to claim 1, wherein a phase adjusting capacitor is connected to the primary winding of the first transformer in parallel therewith.

5. The multiple discharge lamp lighting device according to claim 1, wherein a resonant circuit comprising a parasitic capacitance and a self-inductance of the transformer or exciting inductance is formed at a wiring on the secondary side of the transformer, and the inverter means drives a primary winding of the transformer at a frequency near a parallel oscillation frequency of the resonant circuit.

6. The multiple discharge lamp lighting device according to claim 1, wherein a resonant circuit comprising a leakage inductance of the secondary winding of the transformer and a parasitic capacitance is formed at a wiring on the secondary side of the transformer, the inverter means drives the primary winding of the transformer at a frequency near a frequency less than a serial oscillation frequency of the resonant circuit, having the minimum phase difference between a voltage and current on the primary side of the transformer.

7. The multiple discharge lamp lighting device according to claim 1, wherein one of the plurality of the discharge lamps comprises two straight tubes obtained by connecting electrodes on the one-end side thereof or a bending tube, and the primary windings of the first transformer and the second transformer are driven by at least one of the inverter means.

8. The multiple discharge lamp lighting device according to claim 1, wherein the first transformer comprises a transformer having one output.

9. The multiple discharge lamp lighting device according to claim 1, wherein the first transformer comprises a transformer having two or more outputs.

10. The multiple discharge lamp lighting device according to claim 1, wherein the multiple discharge lamp lighting device is used as a backlight for a liquid crystal display device.
